(19) United States
(12) Patent Application Publication
(10) Pub. No.: US 2009/0251284 A1
(43) Pub. Date: Oct. 8, 2009

(54) REMOTE START SYSTEM FOR A MANUAL TRANSMISSION VEHICLE

(76) Inventors: Shane Wilson, Clinton Township, MI (US); John DiCroce, Oceanside, NY (US); Joseph Dentamaro, St. Clair Shores, MI (US)

Correspondence Address: F. CHAU & ASSOCIATES, LLC, 130 WOODBURY ROAD, WOODBURY, NY, 11797, US

(21) Appl. No.: 12/098,179

(22) Filed: Apr. 4, 2008

(51) Int. Cl. G06K 19/00; F02N 17/00

(52) U.S. Cl. 340/5.64; 123/179.2

(57) ABSTRACT

A method for preventing a manual transmission vehicle equipped with a remote start device from starting when the vehicle is in-gear, including: receiving a start signal; beginning a vehicle start sequence; monitoring a sensor while starting the vehicle; and stopping the vehicle from starting when motion is detected by the sensor.

### BACKGROUND OF THE INVENTION

1. Technical Field

The present invention relates to vehicle remote start systems.

2. Discussion of the Related Art

A remote starter allows you to start a car or a truck using a key-fob remote control without having to go outside, for example. If the vehicle's heat or A/C is left on, it turns on when the engine does. Thus, the vehicle can be warmed up on cold days or cooled down on hot days.

In recognition of the fact that a vehicle having a manual transmission may sometimes be left in in-gear when shut off, many remote start systems are not safe for use in association with such vehicles. For example, if a manual transmission vehicle is left in-gear and a remote start command is received, the vehicle may lurch forward and cause personal injury or property loss.

Software solutions have been proposed to prevent this from happening. However, such solutions do not cover the situation where the vehicle is inadvertently put into gear after its engine has been shut off. For this reason, remote start systems employing these methods caution or restrict installation on convertible vehicles, and suggest that the vehicle's windows be closed after the engine has been shut off.

Hardware solutions such as external microwave sensors have also been proposed for use with remote start systems. Although these sensors prevent a manual transmission vehicle from being inadvertently started if it is left in-gear, their highly sensitive fields tend to detect motion that is unrelated to the starting of the vehicle, thus causing the remote start system to be improperly disabled, for example. In addition, since these devices are generally user-adjustable, many vehicle owners have taken it upon themselves to adjust the sensor's sensitivity range, thereby making it too sensitive or not sensitive enough for proper usage. Further, many installers of such remote start systems have decided not to connect the sensor and thus forgo this feature.

Accordingly, there exists a need for a remote start system that accurately detects when a vehicle with a manual transmission is in-gear and that prevents the vehicle from starting when it is in-gear.

### SUMMARY OF THE INVENTION

In an exemplary embodiment of the present invention, a method for preventing a manual transmission vehicle equipped with a remote start device from starting when the vehicle is in-gear, comprises: receiving a start signal; beginning a vehicle start sequence; monitoring a sensor while starting the vehicle; and stopping the vehicle from starting when motion is detected by the sensor.

The method further comprises allowing the vehicle to start when no motion is detected by the sensor.

The vehicle start sequence includes an accessory interval, an ignition interval and a crank engine interval.

The monitoring takes place during the entire vehicle start sequence or only during the crank engine interval.

The sensor is monitored a plurality of times during the vehicle start sequence.

The detected motion must exceed a preset threshold to cause the vehicle to be stopped from starting.

The method further comprises: after the start signal has been received, determining if the vehicle has been entered since receipt of a last successful shut down signal or since a last successful run timer shut down, wherein when the vehicle has been entered: disallowing the vehicle from being started, wherein when the vehicle has not been entered: proceeding to the vehicle start sequence.

In an exemplary embodiment of the present invention, a remote start system for a manual transmission vehicle, comprises: a remote start device for enabling the vehicle to be started upon receipt of a start signal, the remote start device including a receiver for receiving the start signal, a plurality of input and output ports for connecting to a plurality of devices in the vehicle, and a sensor for monitoring movement of the vehicle when an engine of the vehicle is cranked; and a remote control for transmitting the start signal to the remote start device.

The sensor may be an accelerometer, a jar switch or a tilt switch.

The remote start device further includes a memory for storing a remote start routine.

The remote start routine begins a start engine sequence upon receipt of the start signal, causes the sensor to monitor movement of the vehicle during the start engine sequence and causes the remote start device to stop the engine from cranking when movement is detected.

The start engine sequence begins after receipt of a last successful shut down signal or after a last successful run timer shut down.

In an exemplary embodiment of the present invention, an add-on for a remote start system for a manual transmission vehicle, comprises: an input/output port for connecting to a remote start device and a plurality of vehicle components; a memory for storing a remote start routine; and a sensor for monitoring movement of the vehicle when an engine of the vehicle is cranked during the remote start routine.

The memory may be a nonvolatile memory.

The sensor may be an accelerometer, a jar switch or a tilt switch.

The add-on can be connected to a remote start device already installed in a vehicle.

The remote start routine begins a start engine sequence upon receipt of the start signal, causes the sensor to monitor movement of the vehicle during the start engine sequence and causes the remote start device to stop the engine from cranking when movement is detected.

The start engine sequence is activated only after a successful exit procedure.

The exit procedure includes activating remote start shut down, removing a key from an ignition cylinder of the vehicle, exiting the vehicle without pressing a brake pedal of the vehicle, closing all doors of the vehicle and placing the remote start routine in a ready mode.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 is a flowchart that illustrates a remote start exit routine for a manual transmission vehicle according to the prior art;

FIG. 2 is a block diagram that shows a remote start system for a manual transmission vehicle according to an exemplary embodiment of the present invention;

FIG. 3 is a flowchart that illustrates a remote start routine for a remote start system for a manual transmission vehicle according to an exemplary embodiment of the present invention;

FIG. 4 is a block diagram that shows an add-on module for a remote start system for a manual transmission vehicle according to an exemplary embodiment of the present invention; and

FIG. 5 is a table that illustrates how an add-on module for a remote start system for a manual transmission vehicle is to be connected to the system and to the vehicle according to an exemplary embodiment of the present invention.

### DETAILED DESCRIPTION OF EXEMPLARY EMBODIMENTS

Described herein, in accordance with exemplary embodiments of the present invention, is a remote start device and a remote start add-on module that include a motion sensor and associated firmware that, when installed in a vehicle having a manual transmission, will cause interruption or cessation of the remote start device from completing an engine start sequence if the sensor becomes active during the start sequence; thus, preventing the starting of the vehicle if it is inadvertently left in-gear.

For example, in a vehicle having a manual transmission with a conventional remote start device installed therein, software has been used to insure that the vehicle is not left in-gear. The software follows a procedure like shown:

1) Arrive at final destination;

2) Engage the parking brake;

3) Activate remote start transmitter switch to keep the vehicle running;

4) Open the driver's door, exit vehicle and close all doors; and

5) Activate the remote start transmitter switch to shut off the vehicle.

Under this exit procedure, the vehicle is assumed not in-gear and a user is allowed to remotely start the vehicle one time thereafter. However, if someone were to reach through a window, they could inadvertently bump the shift selector into gear, for example. Thus, if the vehicle were subsequently remote started, the vehicle could run away on its own.

However, with the remote start device or remote start add-on module according to the present invention, if the gear selector were inadvertently moved into gear, the next time the vehicle remote start is triggered and the starter is engaged, movement of the vehicle during an engine crank sequence would be detected by the motion sensor, for example. Thus, the remote start device will be caused to stop cranking the engine or the engine will be shut down entirely. This will prevent, or at least reduce, the possibility of the vehicle from lurching forward and, in turn, reduce the possibility of causing personal injury or property loss and the inherent liability associated with the same.

A more detailed description of the present invention is now provided.

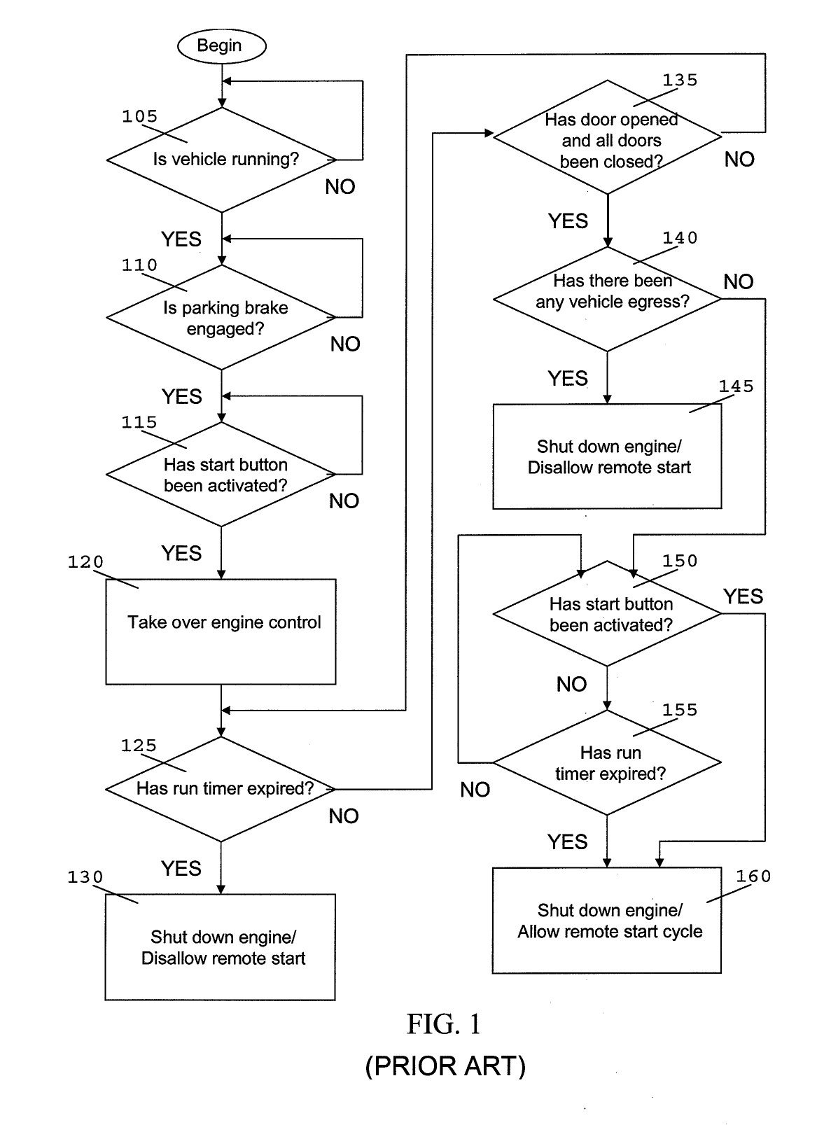

FIG. 1 is a flowchart that illustrates a remote start exit routine for a manual transmission vehicle according to the prior art.

The following description is made with reference to a conventional remote start system such as that which includes a remote start device installed in the vehicle and which is externally operable via remote control.

As shown in FIG. 1, the remote start exit routine begins by determining if the vehicle is running (105). If the vehicle is not running, step 105 is repeated. If the vehicle is running, the routine determines if the parking brake is engaged (110). If the parking brake is not engaged, step 110 is repeated. If the parking brake is engaged, the routine determines if a button on the remote control has been pressed to activate the remote start exit sequence (115). If the button has not been pressed, step 115 is repeated. If the button has been pressed, the remote start device takes over control of the vehicle's engine (120). After engine control has been established, the routine determines if a run timer has expired (125). The run timer can be located in the remote start device and is set to keep the vehicle running for five minutes after the remote start exit sequence has begun, for example. If the run timer has expired, the engine is shut down and a subsequent remote start is disallowed (130). If the run timer is not expired, the routine determines if a door has opened, a driver's door, for example, and if and all of the vehicle's doors have been subsequently closed (135). If the driver's door has not been opened and all of the vehicle doors have not been subsequently closed, step 125 is repeated. If the driver's door has been opened and all of the vehicle doors have been subsequently closed, the routine determines if there has been any vehicle egress (140). If there has been any vehicle egress, the engine is shut down and a subsequent remote start is disallowed (145). If there has been no vehicle egress, the routine determines if a button on the remote control has been pressed to shut down the vehicle's engine (150). If the button as been pressed, the engine is shut down and a subsequent remote start will be allowed (160). If the button has not been pressed, the routine determines if the run timer has expired (155). If the run timer has not expired, step 150 is repeated. If the run timer has expired, the engine is shut down and a subsequent remote start will be allowed (160).

As can be seen, in a conventional remote start system employing such a software routine, if a subsequent remote start is allowed and the shift selector were put into first gear, the vehicle would start up upon receipt of a remote start signal transmitted from the remote control, thus causing the vehicle to lurch forward or runaway, for example. In addition, if the remote start routine is not stopped by a user who notices that their car is acting improperly, the vehicle may repeatedly lurch forward until the routine stops trying to start the car after a preset number of tries.

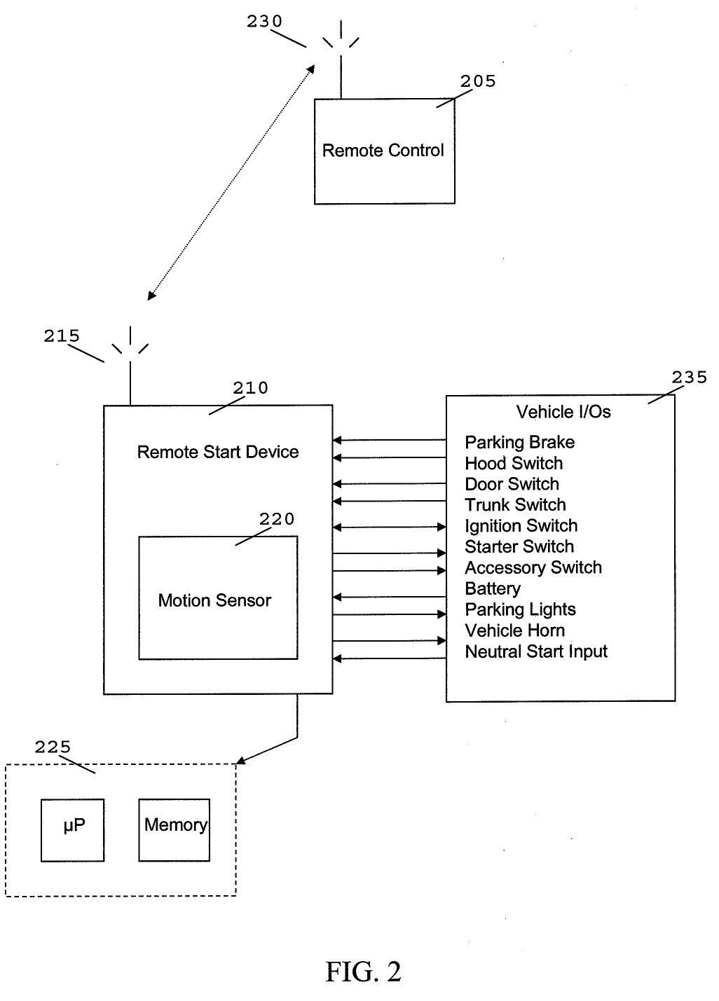

FIG. 2 is a block diagram that shows a remote start system for a manual transmission vehicle according to an exemplary embodiment of the present invention.

As shown in FIG. 2, the system includes a remote control 205 and a remote start device 210. The remote start device 210 includes a receiver 215, a motion sensor 220 and hardware 225 such as a microprocessor (μP) and memory. The remote control 205 includes a transmitter 230 and an input means (not shown), such as a keypad or buttons, for receiving input from a user to control the remote start device 210. Control commands input by a user are sent via the transmitter 230 and received at the receiver 215 of the remote start device 210. The remote start device 210 also includes input and output ports for connecting to various vehicle inputs and outputs (e.g., devices).

The motion sensor 220 may be an accelerometer, jar, tilt or any other mechanical or electrical switch that it capable of detecting motion, for example. The memory is, for example, a nonvolatile memory that stores firmware/software.

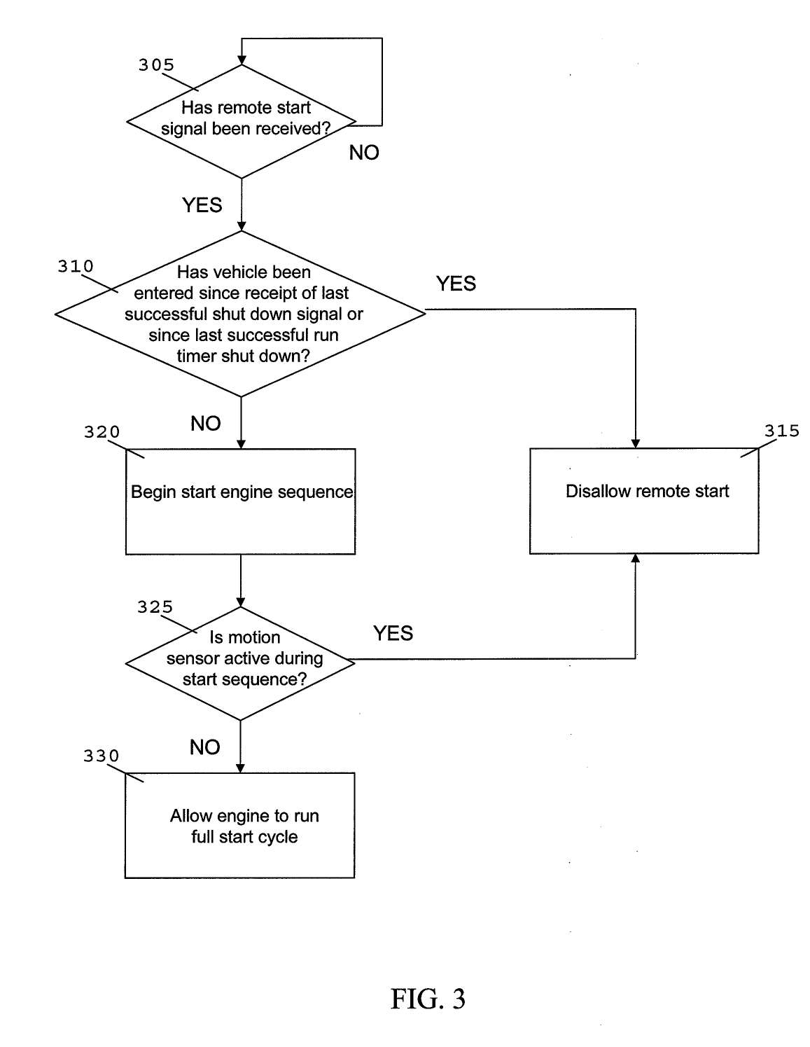

FIG. 3 is a flowchart that illustrates a remote start routine for a remote start system for a manual transmission vehicle according to an exemplary embodiment of the present invention.

The following description is made with reference to the remote start system shown in FIG. 2. It is understood that the routine is stored in the memory of the remote start device 210.

As shown in FIG. 3, the routine checks to see if a remote start signal sent from the remote control 205 has been received by the remote start device 210 (305). If a remote start signal has not been received, step 305 is repeated. If a remote start signal has been received, the routine determines if the vehicle has been entered since receipt of a last successful shut down signal or since a last successful run timer shut down (310). A last successful shut down signal or a last successful run timer shut down is that which would result in step 160 of FIG. 1 being executed, for example. This feature (step 310) prevents any subsequent restart attempts from occurring, unless the correct remote start exit procedure is followed. If the vehicle has been entered, the remote start is disallowed (315). If the vehicle has not been entered, the start engine sequence begins (320). During this time, the motion sensor 220 is monitored to see if vehicle motion is detected (325). If motion is detected, the remote start is disallowed (315). This is accomplished by causing the remote start device 210 to shut down all systems in the vehicle that have become active up to that point, for example. If no motion is detected, the engine is allowed to run its full start cycle (330).

The monitoring step 325 will now be discussed in detail. Here, the motion sensor 220 is monitored during the entire start engine sequence, which consists of an accessory interval, an ignition interval and a crank engine interval, or it is monitored during only the crank engine interval, for example. The monitoring may take place once every 200 ms, for example. The motion sensor 220 can be configured to identify motion that is above a preset threshold. For example, an amplitude can be set so that any motion thereunder, such as that which normally occurs during the start sequence, will not trigger the motion sensor 220 and thus not allow the vehicle to be remotely started.

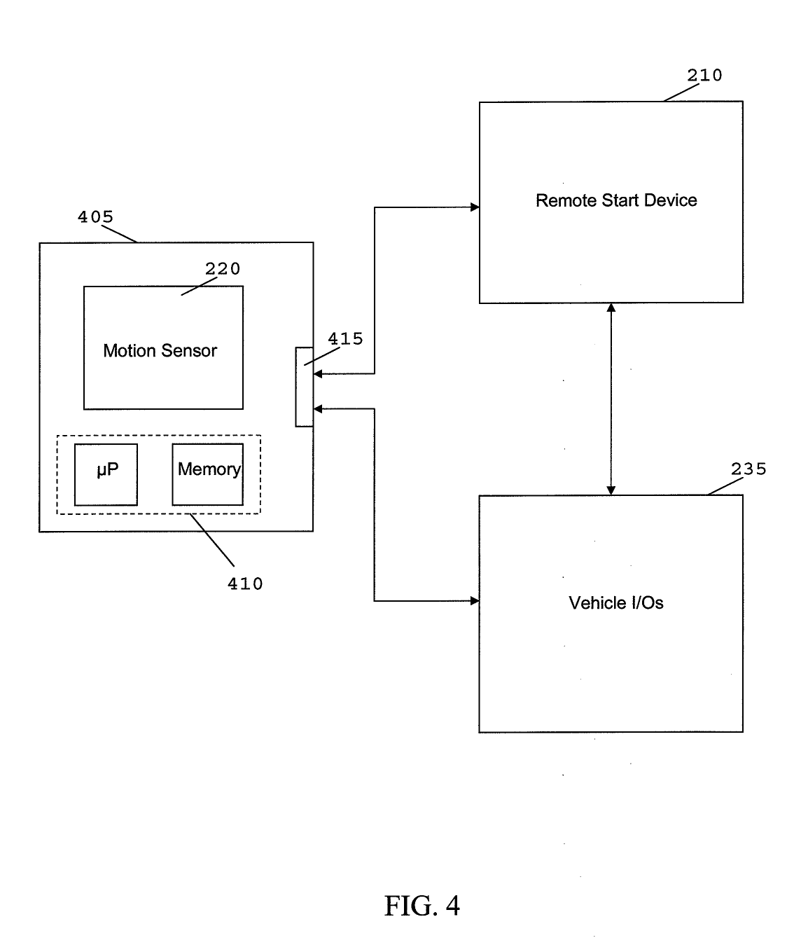

Although the routine shown in FIG. 3 has been described with reference to the remote start system of FIG. 2, it is understood that this routine can be stored in a memory that is part of an add-on module to the remote start system. An example of such an add-on module is shown in FIG. 4.

As shown in FIG. 4, an add-on module 405 includes the motion sensor 220 and its own on-board hardware 410 such as a μP and memory. The module 405 connects to an existing remote start device 210 (either in a vehicle or not yet installed) and to vehicle inputs and outputs 235. The remote start device 210 to which the add-on module 410 is connected can be any known remote start device, for example.

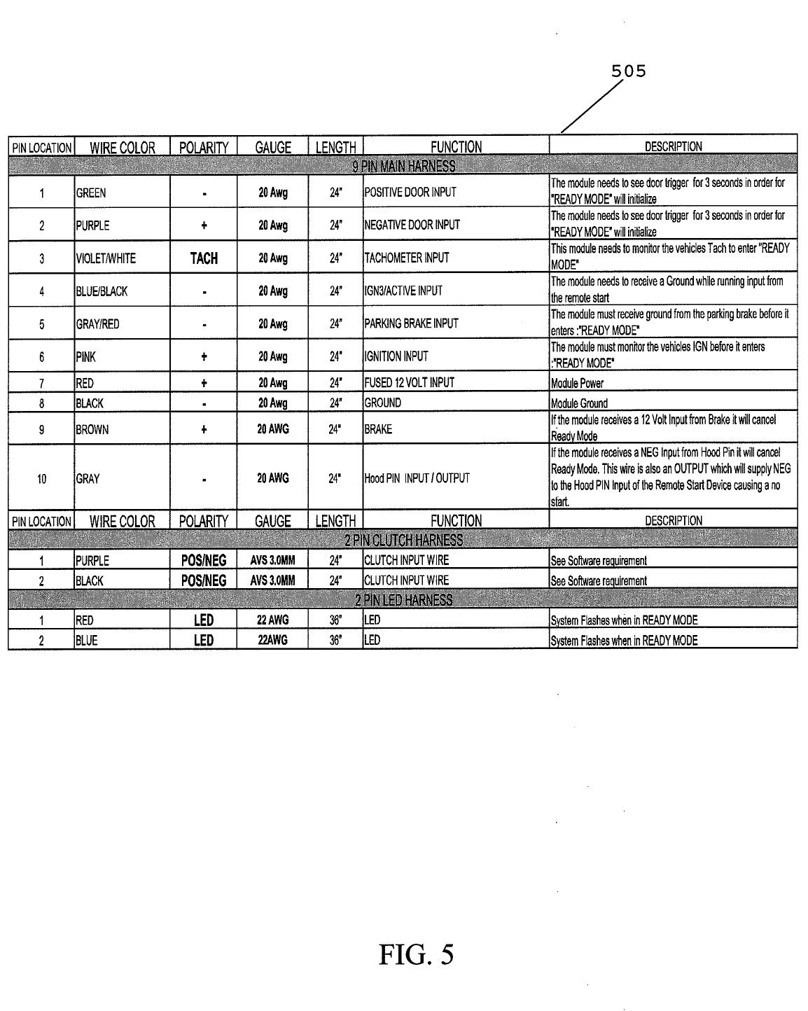

The module 405 connects to the remote start device 210 and the vehicle inputs and outputs 235 via pin location 415, for example. Table 505 in FIG. 5 illustrates how these connections can be made. For example, as shown in Table 505, pin locations 1-10 correspond to pin locations 415, which connect the module 405 to the remote start device 210 and/or the vehicle inputs and outputs 235.

Some aspects of Table 505 will now be described.

In particular, in Table 505, one of the Description columns refers to “See software requirement”. The software requirement is as follows.

For a Negative Clutch System: One wire at a clutch switch will show a constant ground. The other wire goes to ground when the clutch is pressed. Here, Purple is wired to a constant wire and Black to a switched wire. When PIN 4 (Blue/Black) is active and the module 405 is in READY MODE, an on-board relay will close, essentially closing the clutch wire connection.

For a Positive Clutch System: One wire at the clutch switch will show +12V constant. The other wire goes to 12V when the switch is pressed (some vehicles require the ignition to be on). Here, Purple is wired to the constant wire and Black to the switched wire. When PIN 4 (Blue/Black) is active and the module 405 is in the READY MODE, the on-board relay will close, essentially closing the clutch wire connection.

For a Direct Feed Clutch System: One wire will show 12V when a key is turned to a start position. The other wire will show 12V when the key is in the start position and the clutch is pressed. Basically, all the clutch is doing is breaking the starter wire. Here, Purple is wired to key side and Black to solenoid side. When PIN 4 (Blue/Black) is active and the module 405 is in the READY MODE, the on-board relay will close, essentially closing the clutch wire connection.

Ready Mode—If, for example, the exit routine shown in FIG. 1 is successful, when the engine is shut down in step 160, the module 405 will enter a READY MODE. At rest the module 405 will provide a GROUND output on PIN 10—GRAY Hood PIN (INPUT/OUTPUT). This output will wire directly to the remote start device 210 hood PIN INPUT, which will allow the system to remote start. If in READY MODE, the module 405 will supply an open to a safety input of the remote start device 210, thereby allowing operation.

Also in READY MODE, an LED will turn ON and stay ON solid while the “Ready Mode” routine is in process and flash once the system is in READY MODE or if the process was successful.

An exemplary technique, in which the “Ready Mode” may be engaged, is described as follows:
1) All doors must be closed;
2) Key start engine;
3) Fully apply parking brake;
4) Put transmission in neutral and release clutch pedal;
5) Engage remote start. Parking lights will flash or illuminate depending on the remote start model;
6) Remove key from ignition cylinder;
7) Exit vehicle without pressing brake pedal.
8) Shut all vehicle doors. The engine will shut off 30 seconds after the doors are closed by supplying a NEG output pulse to (PIN 10 hood PIN) the remote start device 210. User can also shut down the remote start device 210 via the remote control 205 within the 30 seconds and set the READY MODE.

The remote start system is now ready for remote start. If the vehicle does not shut down after the Hood PIN is pulsed (because the module 405 senses tachometer or ignition after closing all the doors and shutting down the system), “Ready Mode” will cancel. The vehicle will have to be re-entered and steps 1-8 will have to be repeated.

Once the vehicle has been set up in READY MODE and the engine has shut off, the remote start system can be used to start the vehicle at any time. However, if any of the inputs (Door, Brake, Hood or Motion) are detected, the READY MODE will be canceled and the module 405 will prevent the remote start device 210 from starting the vehicle (by supplying PIN 10 to Ground). In this case, the module 405 will need to be re-setup for “Ready Mode”.

It is understood that the present invention may be implemented in various forms of hardware, software, firmware, special purpose processors, or a combination thereof. In one embodiment, the present invention may be implemented in software as an application program tangibly embodied on a program storage device (e.g., magnetic floppy disk, RAM, CD ROM, DVD, ROM, and flash memory). The application program may be uploaded to, and executed by, a machine comprising any suitable architecture.

It is also understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

It is further understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention.

It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A method for preventing a manual transmission vehicle equipped with a remote start device from starting when the vehicle is in-gear, comprising:
receiving a start signal;
beginning a vehicle start sequence;
monitoring a sensor while starting the vehicle; and
stopping the vehicle from starting when motion is detected by the sensor.

2. The method of claim 1, further comprising:
allowing the vehicle to start when no motion is detected by the sensor.

3. The method of claim 1, wherein the vehicle start sequence includes an accessory interval, an ignition interval and a crank engine interval.

4. The method of claim 1, wherein the monitoring takes place during the entire vehicle start sequence.

5. The method of claim 3, wherein the monitoring only takes place during the crank engine interval.

6. The method of claim 1, wherein the sensor is monitored a plurality of times during the vehicle start sequence.

7. The method of claim 1, wherein the detected motion must exceed a preset threshold to cause the vehicle to be stopped from starting.

8. The method of claim 1, further comprising:
after the start signal has been received, determining if the vehicle has been entered since receipt of a last successful shut down signal or since a last successful run timer shut down,
wherein when the vehicle has been entered:
disallowing the vehicle from being started,
wherein when the vehicle has not been entered:
proceeding to the vehicle start sequence.

9. A remote start system for a manual transmission vehicle, comprising:
a remote start device for enabling the vehicle to be started upon receipt of a start signal, the remote start device including a receiver for receiving the start signal, a plurality of input and output ports for connecting to a plurality of devices in the vehicle, and a sensor for monitoring movement of the vehicle when an engine of the vehicle is cranked; and
a remote control for transmitting the start signal to the remote start device.

10. The remote start system of claim 9, wherein the sensor is an accelerometer, a jar switch or a tilt switch.

11. The remote start system of claim 9, wherein the remote start device further includes:
a memory for storing a remote start routine.

12. The remote start system of claim 11, wherein the remote start routine begins a start engine sequence upon receipt of the start signal, causes the sensor to monitor movement of the vehicle during the start engine sequence and causes the remote start device to stop the engine from cranking when movement is detected.

13. The remote start system of claim 12, wherein the start engine sequence begins after receipt of a last successful shut down signal or after a last successful run timer shut down.

14. An add-on for a remote start system for a manual transmission vehicle, comprising:
an input/output port for connecting to a remote start device and a plurality of vehicle components;
a memory for storing a remote start routine; and
a sensor for monitoring movement of the vehicle when an engine of the vehicle is cranked during the remote start routine.

15. The add-on of claim 14, wherein the memory is a nonvolatile memory.

16. The add-on of claim 14, wherein the sensor is an accelerometer, a jar switch or a tilt switch.

17. The add-on of claim 14, wherein the add-on is connected to a remote start device already installed in a vehicle.

18. The add-on of claim 14, wherein the remote start routine begins a start engine sequence upon receipt of the start signal, causes the sensor to monitor movement of the vehicle during the start engine sequence and causes the remote start device to stop the engine from cranking when movement is detected.

19. The add-on of claim 14, wherein the start engine sequence is activated only after a successful exit procedure.

20. The add-on of claim 19, wherein the exit procedure includes activating remote start shut down, removing a key from an ignition cylinder of the vehicle, exiting the vehicle without pressing a brake pedal of the vehicle, closing all doors of the vehicle and placing the remote start routine in a ready mode.
